(19) United States
(12) Patent Application Publication
(10) Pub. No.: US 2007/0077124 A1
(43) Pub. Date: Apr. 5, 2007

(54) Method of treating municipal solid waste offshore: alternative to incineration and landfill

(76) Inventor: Victor Navarro Corpus, Manila (PH)

Correspondence Address: Victor N. Corpus, 9 Larsen Court, Bridgewater, NJ, 08807, US

(21) Appl. No.: 11/243,276

(22) Filed: Oct. 4, 2005

(51) Int. Cl. B09B 1/00

(52) U.S. Cl. 405/129.1

(57) ABSTRACT

A method of treating municipal solid waste by first segregating the recyclables, the non-recyclables, and the biodegradable waste. Recyclables are sold to recycling firms. Non-recyclables are reduced by crushing, shredding, grinding or compaction; and sealed airtight in segmented, double-hulled, flat-topped floating vessels that serve as platforms for composting or vermi-composting the biodegradable portion of the municipal waste. Thus, the recyclables are recovered and reused; the biodegradable materials are plowed back into the ecosystem as soil conditioner; and the non-recyclables are reduced and disposed off without the common by-products of incinerators and landfills like dioxins, furans, heavy metals, toxic ashes, greenhouse gases, and leachates polluting air, land, and water resources. The method offers a solution to a long-standing insoluble problem of where to dispose municipal waste, and how to do it without polluting the environment. In the end, the city gets the added benefit of a never-ending, ever-expanding floating real estate.

### BACKGROUND OF THE INVENTION

The present invention relates to the treatment and disposal of municipal solid wastes, and more specifically to the treatment and disposal of municipal solid wastes offshore.

There are two principal methods of municipal solid waste disposal used in the world today: incineration and sanitary landfill. These methods of disposing waste, however, come with serious environmental consequences.

Incinerators. Incinerators burn municipal waste to convert the waste into energy. The big problem with incinerators is that they also convert waste into hazardous air emissions and toxic ashes. In burning waste, Incinerators spew carcinogenic and toxic elements from their smoke stacks; including dioxin compounds, lead, mercury, cadmium, nitrous oxide, arsenic, fluorides, and particulates that can be inhaled and lodge permanently in the lungs. Dioxin was identified by the World Health Organization as a known human carcinogen in 1997. Dioxin has been found to rapidly build up in the food chain. From Incinerator smoke stacks, tiny dioxin particles attach to dust particles and travel long distances. It lands on grass and animal feed wherein it bio-accumulates as it moves up in the food chain. When people eat or drink the contaminated animal product, the dioxin in the animal body is transferred to humans. Dioxin is known to contaminate human breast milk; and these, in turn, are transferred to their babies. It is also linked to birth defects, immune system dysfunction, hormonal imbalances, male infertility and other health problems. People around incinerators can be affected by dioxin either indirectly through the food chain; or directly, through inhalation of polluted air or drinking water contaminated by this hazardous pollutant.

Some incinerators may be equipped with expensive filters in their smoke stacks (a luxury which most developing countries cannot afford or care to install), but despite such precautions, air pollution from incinerators remain a serious problem. Filtering the hazardous emissions only makes the residual ashes even more toxic. About 10-30% of the burned waste materials are converted into ash. The problem again is where to dispose of these toxic residues laden with heavy metals, dioxins and furans. Disposing them in landfills only endangers underground water reservoirs and aquifers even more.

Another serious issue raised on the use of incinerators for waste disposal is the permanent loss of resources that can be recovered from garbage. Aside from non-biodegradable materials that can be recovered for reuse or recycling, the biodegradable portion of the waste can be turned into compost and plowed back into the ecosystem. Incinerators bum them all, and in the process, create more environmental problems than they intended to solve.

Sanitary Landfills. Sanitary landfills, on the other hand, bury the mixed municipal waste in the ground. The most serious drawback of this method of waste disposal is the contamination of water ways and aquifers. There are more than 2,000 landfills in the U.S. today, and more than 75% of these have no lining to protect the nearby aquifers from being contaminated by the leachates emanating from landfills. Leachates are the liquid mixtures produced by rainwater passing through a landfill. When rainwater percolates through the waste material, traces of lead, mercury, cadmium and other toxic contaminants are mixed with the liquid. Leachates from landfills that seep into aquifers or find their way into waterways pollute and render water supplies unfit for human use. To realize the gravity of this problem, let us take the case of the Fresh Kills Landfill in New York, considered as the largest manmade object in the world covering some 3,000 acres and about 200 feet high. This famous landfill leaks an estimated 1 million gallons of leachate into the surrounding water table every year (Miller).

Although about 70% of the earth's surface is covered with water, only less than 1% of water in the planet is available for sustaining life; and most of these can be found in underground water reservoirs or aquifers. About 50% of Americans use groundwater for drinking while almost all who live in the rural areas of the U.S. depend on groundwater. Water being the source of life and the most important natural resource is seriously threatened by contamination coming from hundreds of landfill sites dotting the U.S.

Although legislation was passed in the U.S. requiring landfills to install linings to prevent leachates from landfills to contaminate aquifers in 1992, such a solution will only delay eventual pollution of underground water. All linings have finite existence. They will eventually degrade through the years, and in the end the pestering problem remains. When that time comes, the contamination of underground water below the landfill becomes irreversible.

Another problem with sanitary landfills is the hazardous gases they emit to the atmosphere. The landfill Gas Testing Program of the State of California has demonstrated that landfill gases typically contain toxic volatile organic compounds (VOCs) regardless of the type of waste they are designated to accept and that off-site migration of landfill gas is a fairly common occurrence (Hodgson et al. 1992). Landfills produce methane, an explosive gas which is one of the worst contributors to global warming.

Landfills are also rejected by most communities because of the attendant foul odor that usually goes with its operation. And land for use in landfills is becoming more difficult to find because of landfill special requirements. Most landfills in the East Coast of the U.S. are due to close in 5 to 10 years. By then, no community in the area would want the waste dumped in their “backyard” to be another Staten Island. The big problem is where to dump the waste.

Offshore “Septic Tanks”. It is also known in the art to use offshore biogas digesters or septic tanks. This process involves depositing the mixed municipal waste into barges. As the barges are filled up, they are sealed and brought offshore. The waste is allowed to decompose under anaerobic conditions for eighteen (18) months. The barges are envisioned to be equipped with facilities to collect the methane gas produced by the decaying organic matter in the encased waste materials. In short, the barges serve as floating biogas digesters or “septic tanks”. After 18 months, the barges will be reopened and “mined” for whatever can be recovered and recycled.

The aforesaid process has been observed to have some drawbacks in that the collected waste is merely dumped into barges without prior segregation, thus making recycling difficult. The waste is dumped into the barge still wrapped inside plastic waste bags. This precludes the entry of oxygen needed to decompose organic matter. Still wrapped in plastic inside the sealed barges, the methane will not be able to escape from the plastic containers, precluding the efficient collection and use of the methane gas produced in anaerobic decomposition. Instead of being collected, methane gas, CO₂ and hydrogen sulfide will accumulate inside the waste bags, such that opening the barges poses the risk of explosion coming from the gases trapped in the waste bags. An explosion in one bag can trigger the explosion of the rest, since all of the bags contain trapped methane in them.

Another problem of the said method is that the process involves anaerobic decomposition. Studies have shown that anaerobic decomposition, i.e., decomposition in the absence or lack of oxygen, is inefficient and ineffective in decomposing organic waste. In some reported cases in the United States, bananas, hotdogs, chicken with bones, etc. that were thrown in landfills more than a decade ago and underwent the process of anaerobic decomposition remained intact to this day.

### SUMMARY OF THE INVENTION

Accordingly, several objects and advantages of this invention are as follows: a) solve a previously insoluble environmental problem by providing a safe place for disposing and recycling municipal waste; b) solve a long-felt public need for a waste disposal method without the attendant environmental hazards of dioxins, furans, heavy metals, explosive gases, toxic ashes and leachates polluting air, land and water resources which are attendant to incinerators and sanitary landfills; c) reduce waste volume by recovering and reusing recyclables, compacting non-recyclables, and returning biodegradable waste back into the ecosystem; d) integrate waste recycling with food production offshore for the very first time; and e) dispose non-recyclable waste safely that leads to two important, significant, and unexpected new results; i.e., food produced in a unique way offshore and a never-ending, ever-expanding, valuable floating real estate comprising a new approach to land reclamation.

The method of treating municipal solid waste envisioned in this invention starts with segregation of the mixed waste into recyclable, non-recyclable, and biodegradable. The segregation process can be done inland or offshore.

The recyclable items are sorted out and sold direct to recycling firms. The segregated non-recyclable waste are shredded or compacted and sealed in flat-top floating vessels such as ferrocement barges that are towed to an offshore recycling and food production facility where they serve as platforms for compostng/vermi-composting and food production, with a double purpose of also serving as breakwater for the entire offshore complex. In the latter phase of operation, excess waste depository barges with inter-connectors start forming a constantly expanding floating real estate or a new form of land reclamation. This floating real estate can be towed to where the value of real estate is most favorable, or used as building blocks for low cost housing and the like.

The segregated biodegradable portion of the waste, on the other hand, is recycled by means of composting and/or vermi-compostng in combination with food production on top of the floating vessels used as depositories for non-recyclable waste. Livestock manure from the food production process is used as activator to hasten the decomposition process in recycling and composing the segregated biodegradable waste.

The end result of all these is solving a previously insoluble environmental problem of where to dump the municipal waste. It also solves the long-felt need to address the attendant air, land and water pollution that go with current waste treatment methods. In the process, new, unexpected, valuable results are derived, i.e., food produced in a unique way offshore and a never-ending, ever-expanding, floating real estate.

### BRIEF DESCRIPTION OF THE DRAWINGS

FIG. 1 shows a schematic diagram of an offshore municipal solid waste treatment process flow chart. FIG. 1-A shows an input-process-output diagram of the waste treatment process.

FIG. 2 shows a schematic diagram of a pier leading to an offshore segregation facility.

FIG. 3 shows a side view of a portion of an offshore municipal waste treatment facility.

FIG. 3-A shows a perspective view of a vermi-composting barge.

FIG. 3-B shows a perspective view of a food production barge.

FIG. 4 shows the top view of composting/vermi-composting bins on flat-top surface of a vermi-composting barge

FIG. 5 shows a schematic diagram of an offshore municipal waste treatment facility.

FIG. 6 shows a perspective view of an uncovered ferro-cement barge.

### DETAILED DESCRIPTION OF THE DRAWINGS

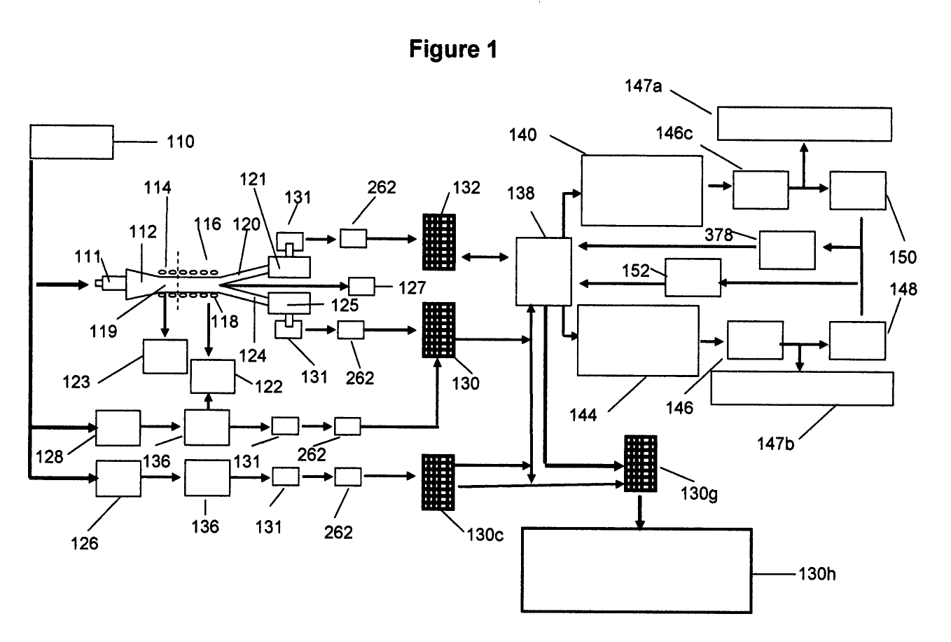

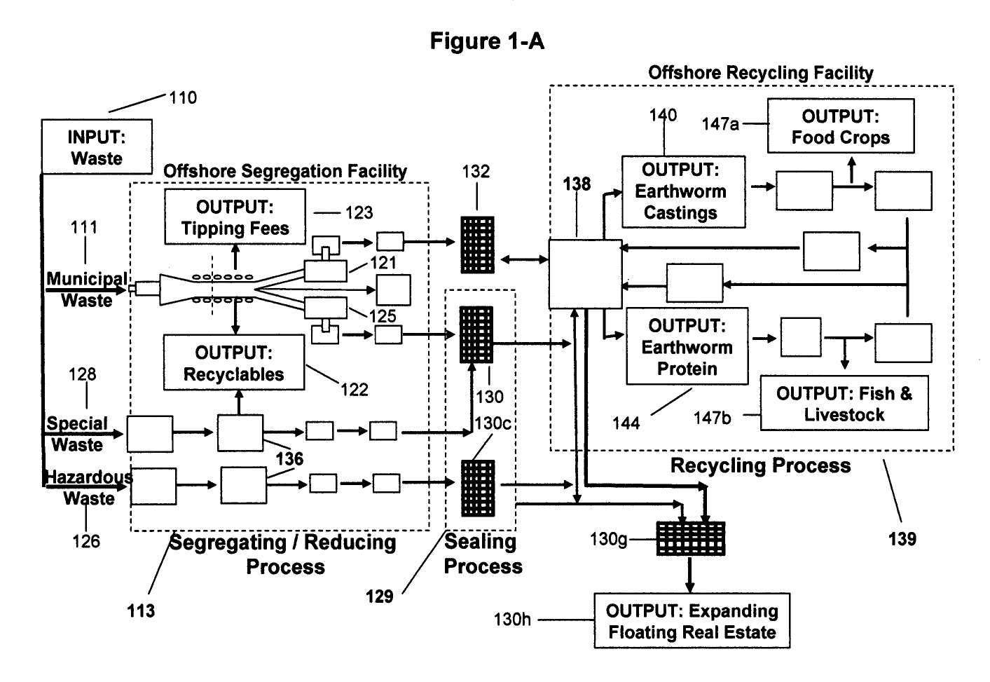

FIG. 1. A preferred embodiment of the municipal waste treatment process is illustrated in the schematic diagram shown in FIG. 1. Urban waste 110 comprising of mixed municipal solid waste 111; special waste 128 such as construction and demolition debris, white goods, tires, and bulky furniture; and hazardous waste 126, except nuclear waste, are brought separately to the segregation facility. Dump trucks deposit the mixed municipal waste 111 on a tapering ramp 112 where the waste materials are removed from their plastic containers at a debagging section 114. Said waste materials are brought by conveyor belt 119 to a segregation section 116 where sorters 118 in protective gear and clothing, and using various manual tools segregate the biodegradable 120 from the non-biodegradable and non-recyclable materials 124. Sorters also separate the recyclable materials 122 to be sold to recycling firms. There will be a series of modular tapering rumps 112 leading to conveyor belts 119 with corresponding grinders, shredders, or compactors to accommodate the daily volume of waste as required in a particular area. Tipping fees 123 are collected as garbage trucks enter the segregation facility to defray operational expenses. Leachates are collected and treated in a leachate pond or barge 127.

The segregated biodegradable materials go to a grinder 121 where the said materials are grinded, seeded with enzyme, lime and zeolite, and loaded by conveyor to transfer bins 131. The filled-up bins, in turn, are covered and loaded by tower crane 262 to a shuttle barge 132 which will bring the waste materials to an offshore municipal waste treatment facility 138.

The non-recyclable materials 124, on the other hand, are reduced by appropriate grinders, shredders, or crushing machines 121, and/or compacted by compactors 125 and also loaded in transfer bins 131. The non-recyclable materials 124 are transferred by tower crane 262, deposited and sealed airtight in flattop floating vessels 130 such as barges preferably made of ferro-cement. It should be appreciated that the floating vessels may also be comprised of either metal or other laminated cementitious composite materials such as fiber-reinforced plastic which are sealed when full. The sealed depository vessels 130 are towed to the offshore waste treatment facility 138 where the sealed vessels serve as composting/vermi-composting platforms, food production platforms, breakwater, and as building blocks for an ever-expanding floating real estate or floating land reclamation.

Special kinds of waste 128 such as white goods (discarded refrigerators, freezers, and the like), bulky furniture, construction and demolition debris, tires, etc. are collected and brought to the segregation facility separately and treated by means of shredding, crushing, grinding or compacting 136 as appropriate; wherein the ferrous and non-ferrous metals as well as other recyclable materials 122 are recovered, while the residual non-recyclables are further reduced by shredding machines or compactors 136 before being deposited and sealed in the depository floating vessels or barges 130.

Hazardous waste 126 are decontaminated, grinded, shredded, crushed or compacted when applicable 136 and deposited in separate ferro-cement barges 130c that will be towed to the offshore facility where they will be kept safe behind a double breakwater.

The biodegradable waste brought by the shuttle barge 132 is unloaded at the offshore waste treatment facility 138 where the materials are piled in concrete bins, composted and fed to earthworms. The waste materials are then converted into earthworm castings 140. In the process of vermi-composting, earthworms are produced that can be harvested, lab-tested for safety, dried and used as earthworm protein meal 144, an important protein ingredient for livestock and fish feed. It should be appreciated that the recycling process for the biodegradable portion of the waste can stop at the composting stage, wherein the composted biodegradable waste can already be plowed back into the eco-system. Livestock production in support of the recycling process, i.e., livestock manure used as activator 152 in the faster decomposition of the biodegradable waste, can be undertaken even without earthworm protein by just using regular livestock feed material bought off the shelf.

The earthworm castings, on the other hand, are mixed with soil and rice hulls to serve as substrate for raising organic products in greenhouses 146c on the top deck of the vermi-compost and food barges resulting in organically-grown food crop output 147a. Part of the output of earthworm castings 140 may be packaged and sold to retailers as soil conditioner. This is one of the outputs and income sources of the process.

The worm protein meal 144, after undergoing proper laboratory testing for safety, can serve as protein feed ingredient for fish and livestock 146 resulting in fish and livestock food output 147b. Manure waste from livestock, livestock casualties, and waste cuttings from the greenhouses serve as activator 152 for composting of the biodegradable waste and as inputs to biogas digesters 378. Residues from biogas digesters, in turn, are fed to earthworms. Hence, the recycling process turns full circle resulting in zero waste.

Excess depository barges 130g may be connected end-to-end and side-by-side and serve as building blocks in an ever-expanding floating real estate 130h or a new form of floating land reclamation offshore. Thus the end result of the whole process is total disposal of municipal solid waste with no concomitant pollution, with food production and floating real estate as unexpected results.

FIG. 1-A. FIG. 1-A shows an input-process-output diagram of the invention. The inputs are urban waste 110 which include municipal solid waste 111; special waste 128, such as white goods, tires, bulky furniture, construction and demolition debris; and some forms of hazardous waste 126, such as hospital waste, electronic waste, etc., with the exception of radioactive waste. The inputs undergo three basic processes: the segregating/reducing process 113; the sealing process 129; and the recycling process 139.

The segregating/reducing process 113 involves the segregation of mixed municipal solid waste into recyclable, non-recyclable, and biodegradable materials, wherein two outputs are derived: recyclable materials 122; and, tipping fees 123. Segregation is combined with reduction of waste by subjecting them to crushing, shredding, grinding, or compacting 121, 125, and 136 as the case may be. Segregation, in effect, greatly reduces the over-all volume of municipal waste by as much as 80% after separating the recyclable and biodegradable materials that can be recycled and reused, or plowed back into the ecosystem. The 20% non-recyclables or residuals that are left are further reduced by shredding and/or compaction by as much as 15:1.

The segregating/reducing process is followed by the sealing process 129, wherein the non-recyclable as well as the hazardous waste are disposed off by sealing the compacted or shredded waste materials airtight in ferro-cement barges 130 and 130c respectively. The excess barges containing non-recyclable and non-hazardous waste 130g form part of a constantly expanding and floating real estate 130h—one of the valuable outputs of this method. Alternatively, the non-biodegradable or non-recyclable waste materials that are not hazardous or non-toxic may be grinded and mixed with sand and cement to produce aggregates or hollow blocks for construction materials, such as low fences, sidewalks, and driveways. This will further reduce the amount and volume of waste that ultimately end up sealed in the barges.

The third and final process is the recycling process 139 wherein the segregated biodegradable waste is recycled by means of a combination of composting/vermi-composting and food production. What comes out of the final process are outputs that include: a) earthworm castings 140; c) organic food crops 147a; d) earthworm protein 144, and, e) fish and livestock 147b.

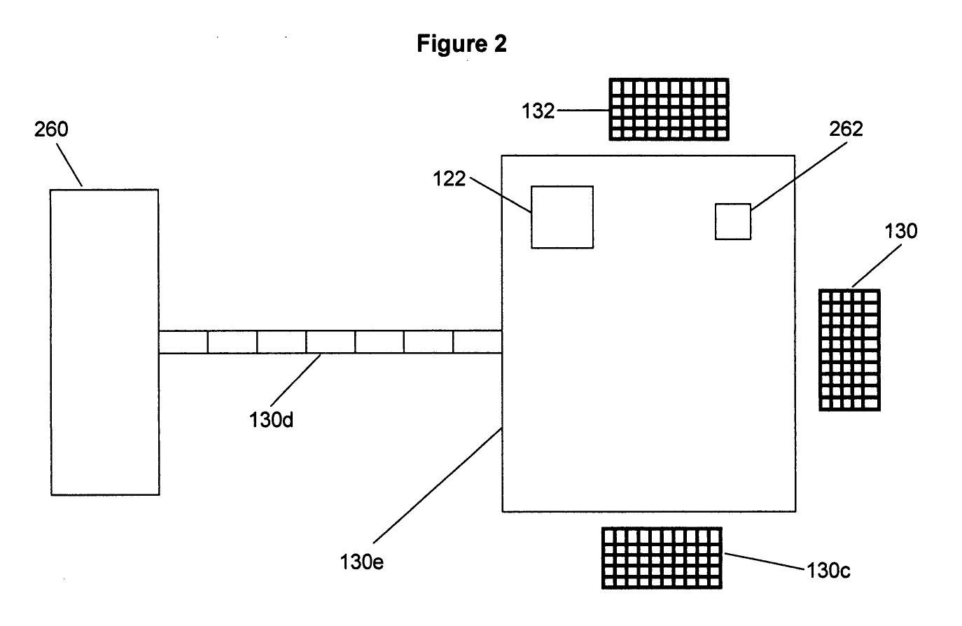

FIG. 2. FIG. 2 shows a schematic diagram of a pier leading to an offshore waste segregation facility. Ferro-cement barges used as depository for non-recyclables are aligned in a single row to form the connecting access road 130d from the pier 260 to an offshore platform. The offshore platform serving as an offshore waste segregation facility 130e are also comprised of filled-up and sealed depository barges connected side-to-side and end-to-end. On top of this floating platform, the collected city waste is segregated into three categories, namely: recyclable, non-recyclable, and biodegradable.

The recyclable materials 122 are separated and stored in a warehouse, or sold immediately to recycling firms. The segregated biodegradable waste goes to a shuttle barge 132 which will bring the material to the offshore composting/vermi-composting facility. The non-recyclable waste, after being shredded and/or compacted, is deposited and sealed in a depository barge 130. The hazardous waste is sealed in a separate barge for hazardous waste 130c. The transfer of the segregated waste materials to their respective barges is facilitated by the use of tower cranes 262.

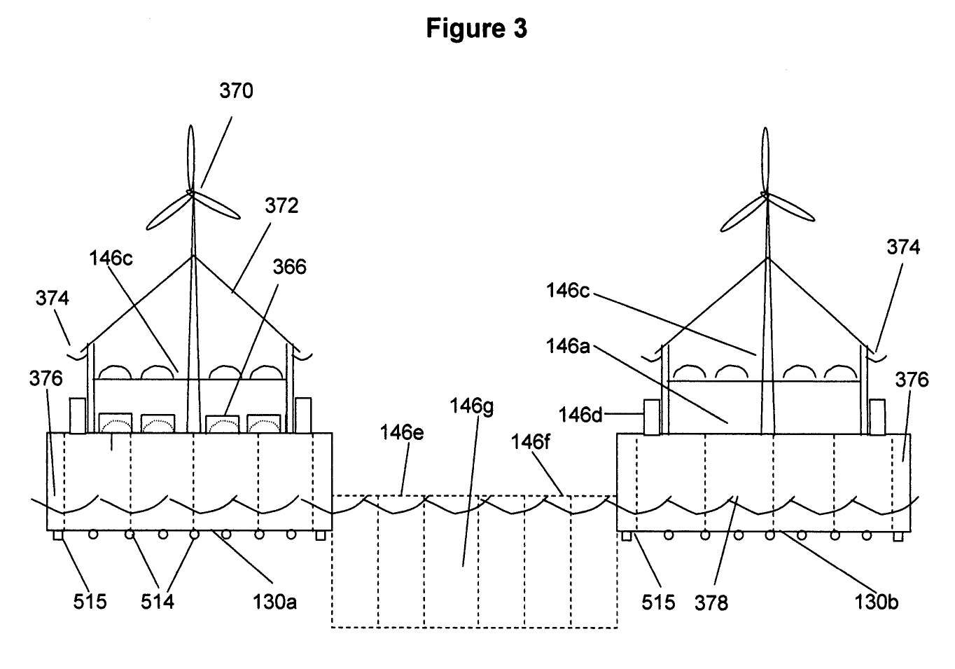

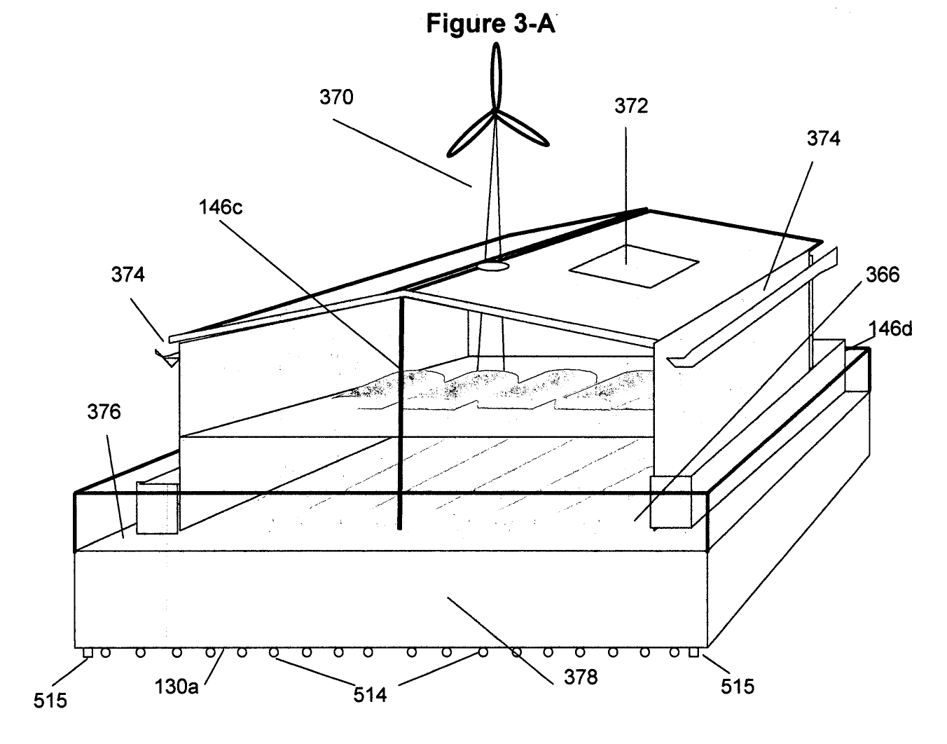

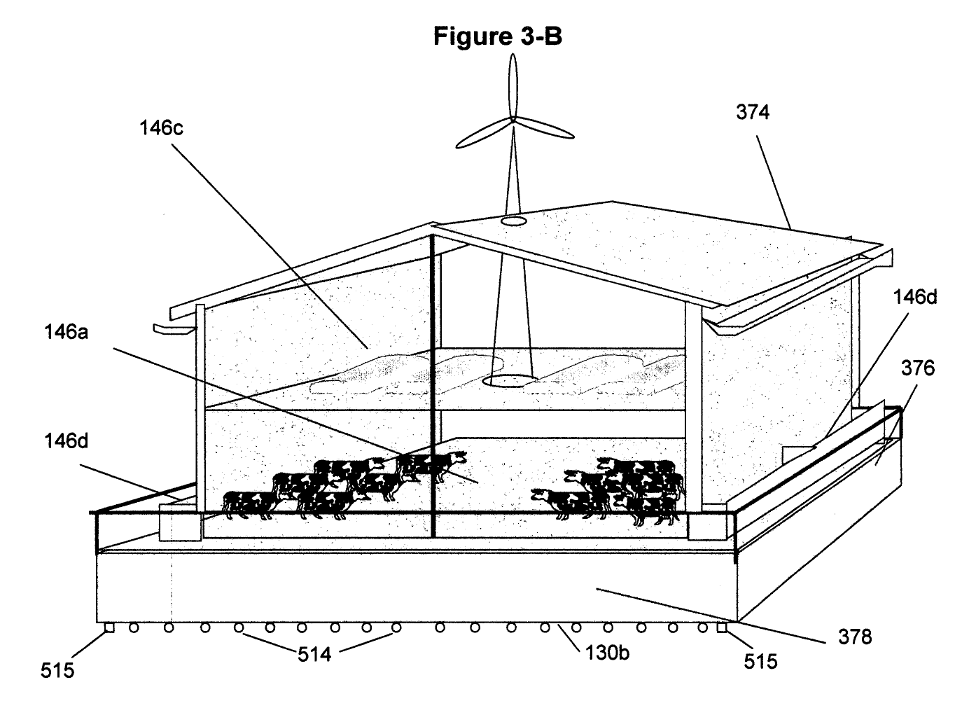

FIG. 3, 3-A, & 3-B. FIG. 3 shows a side view of an offshore municipal waste treatment facility. FIG. 3-A is a perspective view of the vermi-composting barge while FIG. 3-B is a perspective view of the food production barge. The waste depository barge that serves as platform for vermi-composting is the compost barge on the left 130a in FIG. 3. The waste depository barge that serves as platform for food production is the food barge on the right 130b. The compost barge contains concrete vermi-composting bins 366 on the flat-top barge surface for vermi-composting of biodegradable waste. The roof deck is used as greenhouse for raising organically-grown food crops 146c. The roof is provided with solar panels 372 and water catchment device 374 to collect rainwater in built-in water reservoirs 376 on the left and right hulls of each barge.

The food barge 130b is lined parallel to the compost barge 130a to create a controlled sea condition between the two sets of barges, thus allowing fish farming in floating cages 146g, seaweed farming 146e, pearl farming 146f, and artificial coral reef formation 146h. The food barge 130b has a livestock raising area 146a, i.e., cattle, poultry, piggery, etc. done on separate individual barge surface, and raising of organic crops in a greenhouse 146c on the top deck of each barge. It should be appreciated that the arrangement or combination of livestock production and greenhouse in the food barges may vary. Cattle can be raised alone or in combination with food crops in greenhouse on the deck of the barge, or poultry alone or in combination with food crops in greenhouse, or greenhouse alone on the barge surface without any combination with livestock.

Vermi-composting of biodegradable waste in concrete bins 366 produces two valuable products: earthworm castings 140 and earthworm protein meal 144. The earthworm castings produced in the process serve as substrate for greenhouse organic crop raising 146c. Live earthworms serve as feed for freshwater fish raised in concrete tanks 146d. Earthworm protein meal, on the other hand, serves as feed ingredient for cattle/dairy 146a and poultry 146b, after the earthworms are subjected to laboratory tests for safety.

Manure from cattle and poultry serve as activator 152 to hasten the composting and vermi-composting 366 of organic municipal waste. Part of the waste from livestock, to include dead animals and cuttings from the greenhouses shall serve as inputs to generate energy through biogas digesters 378 built into the barge interior. This will complement the energy derived from windmill 370 and solar panel 372 that go with each barge. Rainwater is collected by catchments on the roof of each barge 374 and deposited in water reservoirs 376 built into the left and right hull compartments of each barge. Biogas digesters 378 are built-in at the front and rear hull compartments of each barge. Barge bottom attachments facilitate formation of artificial coral reefs 514, complementing artificial coral reef formations in some of the spaces created between barges that provide controlled sea conditions 146h. Anchor links 515 are also installed at the bottom of each barge post for anchorage.

Freshwater fish in 146d, in turn, serve as feed for saltwater fish in floating fish cages 146g, supplemented by earthworms produced from vermi-compostng 366. In addition to floating fish cages for saltwater fish farming, seaweed farming 146e, pearl culture 146f, and artificial coral reefs 146h are made possible by the controlled sea condition created between the rows of compost barges 130a and food barges 130b. Personnel living space is provided in 368.

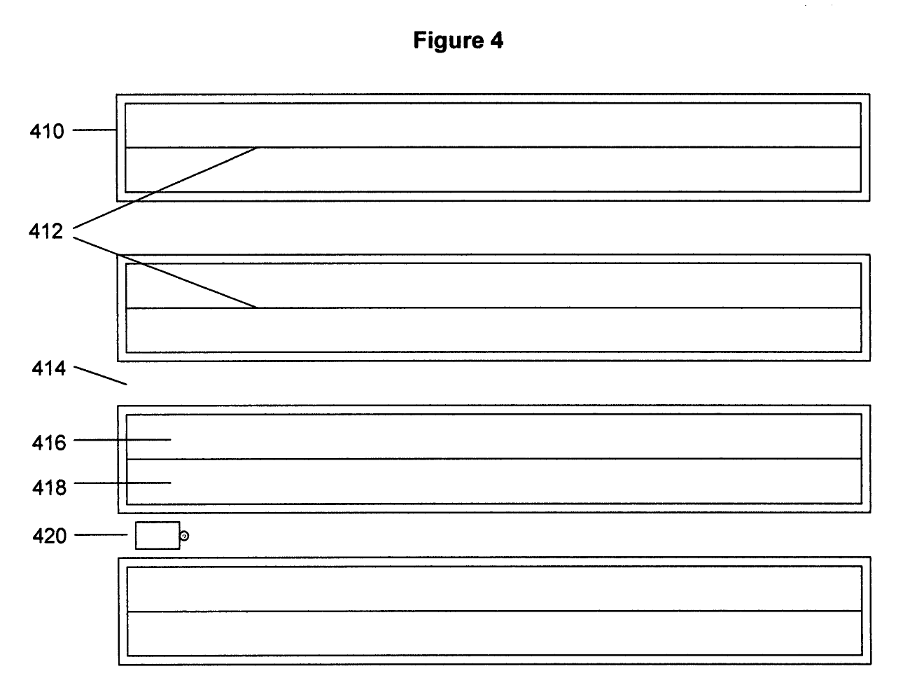

FIG. 4. FIG. 4 shows the top view of vermi-composting bins laid on the flattop surface of the composting barge. The vermi-composting bins 410 are made preferably of concrete 0.6 meters high and 3 meters wide. An alternative embodiment is to do away with bins and simply pile the compost materials in windrows. A 1-cm wire mesh is placed as divider 412 with the same height as the bin to divide each bin into two sections: a first section 416; and a second section 418. Alleys 414 about 2 meters wide are provided between each bin.

The arriving biodegradable waste is piled 0.4-0.5 m high in the first section 416 of the bin 410 and allowed to decompose. Composting of the biodegradable portion of the municipal waste is hastened by seeding with enzymes or activators and/or mixing with dried chicken dung or cow manure. The mixed materials are kept moist and aerated daily using a small tractor 420 with appropriate attachments for aerating the compost piles. The tractor 420 is also provided with other attachments for watering the compost materials in the bins and for loading and unloading materials.

Temperature in the compost piles will increase during the decomposition process which will take about 15 days or more, depending on the size in which the materials have been shredded. The smaller the size of the grinded or shredded materials, the faster will be the decomposition process. When the temperature in the compost pile has gone down to normal, the composted materials are then ready for earthworm seeding.

One kilogram of earthworms per square meter of bin area will consume the composted waste materials in 45 to 60 days. Initially, the seeding rate may be less than this in order to save on cost, since the earthworms multiply and increase in weight very rapidly. They can double in weight in about 60 days. The preferred earthworm species for vermi-composting is Eudrilus eugenie, but other species like Eisenia foetida and Lumbricus rubellus may also be used.

As the waste stream continues, the incoming biodegradable waste is subjected to composing in the second section 418 of the bins following the same procedure as was done on the first section 416. The earthworms in the first section 416 will automatically transfer to the newly composted biodegradable waste in the second section 418 after they have consumed the waste in the first section and converted them into earthworm castings. The castings in the first section are then harvested and replaced with new arrivals of biodegradable wastes for a repeat of the same cycle.

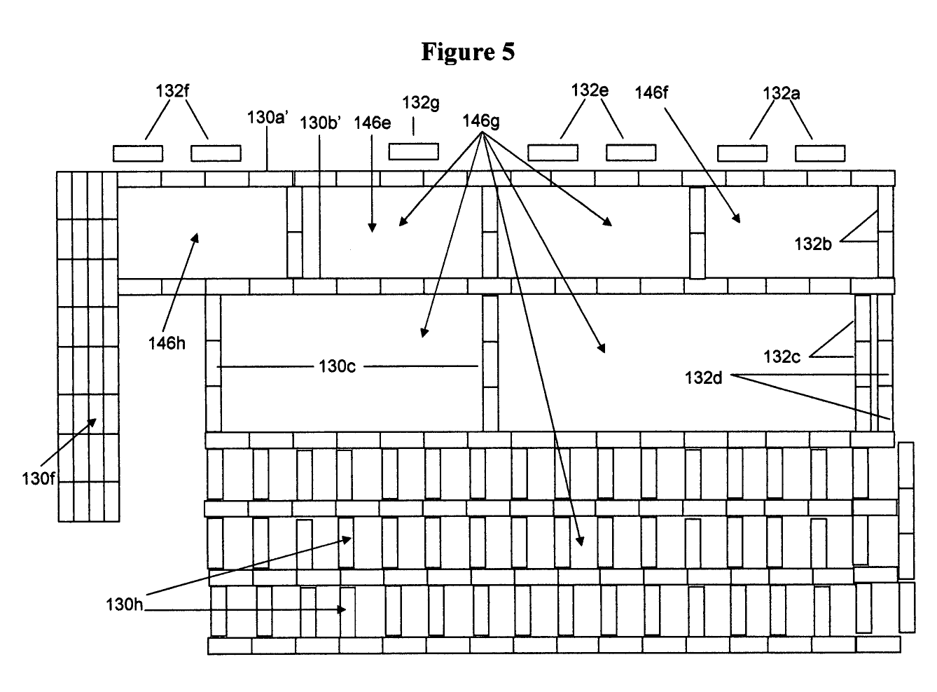

FIG. 5. FIG. 5 shows a schematic diagram of the offshore municipal waste treatment facility (top view). Shuttle barges containing biodegradable waste in transfer bins unload at the landing area 130f. The biodegradable waste materials are then composted and fed to earthworms on compost barges. Compost barges aligned end-to-end serve as the outer breakwater 130a′ while food barges arranged likewise serve as the inner breakwater 130b′, thus creating a double breakwater system for added safety. Barges with hazardous waste 130c are positioned in the interior of the complex for greater protection from the elements.

The barge arrangement creates controlled sea conditions to allow floating fish cages 146g, seaweed farming 146e, pearl culture 146f, and artificial coral reef formation 146h. It must be appreciated that the barge arrangement may be varied, such as arranging the barges like a checker board to create more controlled sea conditions between barges for aquaculture, seaweed farming, pearl culture, and artificial coral reef formation. A desalination plant 132a is installed to provide the water supply complemented by rainwater catchments. Power barges 132b installed with solar panels, windmills, biogas digesters, and equipment for tapping tide, ocean current and wave energy will ensure sustainable power supply for the offshore complex. The extra power generated by these non-traditonal and inexhaustible sources of energy is another output or income source of the system. Dedicated barges serving as water reservoir 132c and oil depot 132d shall form part of the offshore complex. There are also barges dedicated for collection and treatment of waste water 132e, personnel living quarters 132f, and livestock feed-mill 132g. The excess depository barges 130g resulting in continued waste generation from cites and municipalities become building blocks to create an ever-expanding floating real estate 130h constituting a new form of land reclamation.

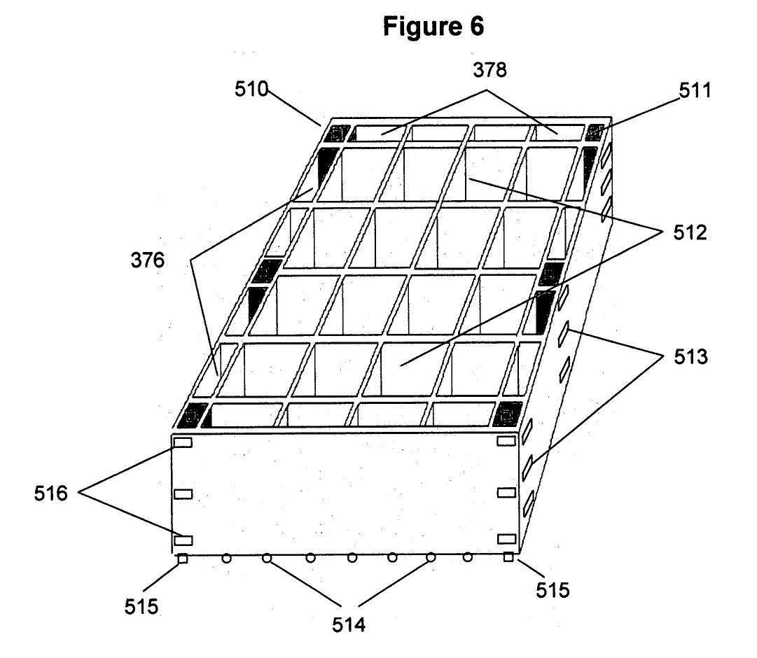

FIG. 6. FIG. 6 shows a perspective view of a floating vessel such as a barge made up of laminated cementitious composites like ferro-cement. An alternative embodiment is a barge made of metal. The front and rear double hulls are utilized as biogas digesters 378. The left and right double hulls are utilized as water reservoir 376 for each vessel. The vessel is divided in segmented compartments 512 which are sealed airtight after being filled with non-recyclable waste. The vessel has major posts 510 with side-to-side 513 and end-to-end 515 connectors and base attachments 511 which enable the floating vessel to be connected end-to-end and side-to-side, as well as facilitate vertical construction on top of the vessel. The number of posts may increase as the vessel length increases. Anchor links are installed at the bottom of each barge post 515. Fiber-reinforced plastic rings 514 will line the flat bottom of the vessel to serve as attachments for plastic ropes and other materials that could be hung at the flat vessel bottom to facilitate the formation of artificial reefs. The top cover used to seal the vessel becomes the flattop vessel surface that serves as multi-purpose platform while the flat bottom of the vessel ensures that the vessel will not capsize and also serves as base for the artificial coral reef 514.

### DETAILS OF THE OPERATION

Waste Segregation. The waste treatment process starts in a waste segregation facility (See FIGS. 1 and 2). Urban waste 110 comprising of mixed municipal solid waste 111, special waste 128 (such as construction and demolition debris, white goods like old refrigerators and freezers, bulky furniture, tires and the like), and some forms of hazardous waste 126 are separately fed into the system. As the waste arrives, the corresponding tipping fee 123 is collected to defray operational expenses. Municipal waste collected by garbage trucks are deposited into a series of tapering ramp with an impact breaker 112 leading to a conveyor belt 119 where sorters in protective clothing 118 positioned on both sides of the conveyor belt debag the waste 114 and using various tools segregate 116 the non-recyclable materials 124 from the biodegradable 120. Recyclable items 122 are also separated to be sold to recycling firms.

Special waste 128 such as construction and demolition debris, white goods (refrigerator, air conditioners, freezers, etc.), bulky furniture (beds, sofas, etc.), tires and the like are collected and treated separately. Freon and compressors are first removed from white goods before they are subjected to processing. Special waste are reduced by crushing, shredding, grinding or compacting 136. Ferrous and non-ferrous metals, plastics, glass and other recyclable materials 122 are recovered before the residual non-recyclable 124 are compacted and sealed in barges 130.

Reduction and Sealing of Non-recyclables. The segregated non-recyclable materials from the municipal waste 111 undergo further reduction either by shredding, crushing, grinding and/or compacting 125. The reduced residuals are then loaded in transfer bins and transferred using a tower crane 262 onto the depository barges 130, which are preferably flattop barges with segmented compartments and double hulls. The barges 130, after being sealed, are towed to the offshore municipal waste treatment facility 138. The flat-top surface of the ferro-cement barges serve as platform for concrete bins used for vermi-composting 366. The compost barges 130a and the food barges 130b are preferably connected end-to-end and parallel to each other so they can also serve as breakwater 130a′ and 130b′ for the entire offshore waste treatment facility 138. As more barges containing non-recyclable wastes are added, the excess barges 130gthen form the beginning of a floating real estate 130h.

In an alternative embodiment, the amount of non-recyclable non-bio-degradable waste deposited on the barges may be significantly reduced by further separating the non-recyclable non-biodegradable waste which are non-hazardous or non-toxic. These materials may be grinded and mixed with sand and cement to produce aggregates, highway sound barriers, road security barriers, or hollow blocks. Separating these materials will free valuable space in the barges which can then be further utilized for other productive purposes.

Hazardous wastes 126 such as discarded electronic items will be collected separately, compacted or shredded when applicable 136, and deposited in separate, segmented, double-hulled barges 130c that will be sealed when filled. Other hazardous wastes will be treated in like manner except those in liquid form that need no compaction. Hospital wastes, on the other hand, can be treated using existing methods in the art and sealed in separate barges where methane-collecting devices are installed. Portions of biodegradable waste contaminated by toxic elements such as heavy metals will also be separated and treated like hospital waste described above.

Recycling Biodegradable Waste. The treatment of the segregated biodegradable materials 120 start by passing through a grinder 121. They are then seeded with activators and deodorizers before being loaded on a shuttle barge 132 that will transport the waste to the offshore waste treatment facility 138. The biodegradable waste is unloaded in a landing area 130f of the offshore facility.

The biodegradable waste is then brought to the vermi-composting platforms 366, piled in the first section of the concrete bin 416 and composted. There are many known methods of vermi-composting. In a preferred embodiment, the process is conducted in concrete bins 0.6 meters high and 3 meters wide. The biodegradable materials are first composted. The decomposition process is hastened by adding enzymes or activators such as dried cow dung or chicken manure. The resulting mixture is then kept moist and aerated daily using a garden tractor with appropriate attachments for compost pile aeration, watering, and loading/unloading of material.

After 15 days or more, the temperature in the compost piles will subside. The earthworms from the adjacent second section 418 will then automatically transfer to the newly composted pile in the first section 416 while the waste material in 418 that has been converted into earthworm casting and the earthworms contained in the piles shall be ready for harvest. Upon clearing the area of the second section 418, new incoming biodegradable waste are laid to begin a new cycle. Thus, the biodegradable waste is converted into earthworm castings 140, one of the finest forms of soil conditioner know to man. Part of the castings output can be packaged and sold, while the rest can be mixed with soil to serve as substrate for organic crop raising in greenhouses 146c on the top decks of the barges.

Another output of the vermi-composting process is earthworms. The preferred earthworm specie for vermi-compostng is Eudrilus eugenie. They multiply very rapidly and consume all types of decomposed organic matter. Other alternative species are Eisenia foetida and Lumbricus rubellus. These earthworms are hermaphrodites capable of reproducing by themselves, such that they can double in weight in about 60 days. After laboratory testing for safety, the earthworms 144 can be dried and used as protein ingredient for fish and livestock feed 146 that will be produced in a feed mill barge 132g.

An alternative embodiment is to recycle the biodegradable portion of the municipal waste by simple composting as already described above and returning the composted materials back to the ecosystem. As to livestock production in support of the recycling process, the livestock can be fed with regular livestock feed available in the market.

The segmented, double-hulled barges (FIG. 6) used for the entire operation follow the principle of the bamboo. Even if holes are created through some segments of the bamboo, the bamboo will still remain afloat. With double-hulls, segmented compartments and flat bottoms, the floating, stationary, sealed structures will be practically unsinkable like the bamboo. To protect the facility from natural calamities, it will be located in coves or harbors, making use of natural covers such as mountain ranges. Vertical construction atop the barges in the later stages can make use of pyramid structures as precaution against strong winds. The waste barges serving as outer breakwater 130a′ and food barges serving as inner double breakwater 130b′ serve as added protection for the offshore colony or community that will form within the offshore complex 138. Against truly strong typhoons, the interconnected barges can be towed away from the typhoon's path. On the worst case scenario, the offshore facility may be temporarily evacuated.

To complete the recycling process for the organic portion of the waste, food barges 130b are set up parallel to the compost barges 130a as shown in FIG. 3. A food production barge consists of a sealed barge containing non-recyclables with one or more floors added on top. The barge surface floor is utilized for livestock 146a such as cattle, dairy, poultry, piggery, etc; while the roof deck is used as a greenhouse for organic crop production 146c using a mixture of worm castings, soil and rice hulls as substrate. The food barge will also contain concrete tanks for fresh water fish 146d. In between the compost barges and food barges are fish cages/nets 146g for the production of salt water fish like groupers. The area between the barges enjoys the benefit of controlled sea conditions, i.e., calmer waters, which can also be used for seaweed production 146e, pearl farming 146f, and artificial coral reef formation 146h.

The earthworms from vermi-composting 144 serve as feed for freshwater fish 146d and as protein ingredient for livestock feed for cattle 146a and poultry 146b. It should be appreciated that regular fish and livestock feed may be used. The freshwater fish 146d, in turn, will serve as feed for saltwater fish production in floating fish cages 146g. Worm castings 140 from vermi-composting are mixed with soil to serve as substrate for organic farming in greenhouses 146c atop the food barges 130b. Manure from the feedlots and poultry 148, and garden wastes from organic farming 150 serve as power source through biogas digesters 378 and later on as additional substrate for vermi-composting in 366. Livestock casualties in the food barges also go to biogas digesters. A portion of the manure from the food barges will be used as activators 152 to hasten decomposition of the biodegradable portion of the municipal wastes. Thus, the recycling cycle turns full circle resulting in zero wastes with no attendant pollution like those generated by incinerators and sanitary landfills.

This whole waste recycling process can be kept odorless. Treatment with zeolite and lime, daily aeration of the compost piles, use of biogas digesters, and earthworm activity in vermi-composting all have the effect of removing any foul odor coming from organic wastes.

As more and more ferro-cement barges are filled up by non-recyclable and non-biodegradable wastes, the vermi-composting area that also serve as breakwater will keep on increasing in area and length. A period will later on be reached when there will be more than enough area to recycle the biodegradable wastes in a given city or locality. As more barges are added as a result of continued generation of wastes from urban centers, a never-ending, ever-expanding floating real estate will sprout literally from the wastes.

Benefits of the Invention. Thus, the method of treating municipal waste as described above is one option for solving a previously insoluble environmental problem of where to dispose the waste, as exemplified by New York City which in 2001 decided to close the largest landfill site in the world but without any immediate viable options for dumping its waste. The method addresses a long-felt public need of disposing municipal wastes without the attendant dangers from dioxins, furans, heavy metals, toxic ashes, greenhouse gases and leachates emanating from current methods of incineration and landfill. As added benefits, a new and unique way of producing food offshore can sprout literally from wastes, with an end result of producing a never-ending, ever expanding, valuable, movable real estate. The latter is like a blank sheet of canvass where modern cities of the future can be drawn. One can see that food, water, and alternative sources of energy can be made available and abundant in a sustainable manner in the offshore environment as described. Thus, this method of disposing and recycling municipal waste may one day contribute to man's colonization of the oceans, which comprise two-thirds of planet earth. Lastly, the jobs that can be generated by this unique process, if adapted by major cities of the world, are simply unimaginable.

A method of treating municipal solid waste by first segregating the recyclables, the non-recyclables, and the biodegradable waste. Recyclables are sold to recycle firms. Non-recyclables are reduced by

What is claimed is:

1. A method of treating and disposing municipal solid waste by:
segregating said municipal solid waste into biodegradable, recyclable, and non-recyclable waste;
sealing said non-recyclable waste materials segregated from said mixed municipal solid waste within a plurality of floating vessels; and
treating said biodegradable waste segregated from said mixed municipal solid waste on top of said plurality of floating vessels by composting or vermi-composting.

2. The method of treating and disposing municipal solid waste according to claim 1, wherein said composing or vermi-composting occurs on a first one of said plurality of floating vessels and food production occurs on at least a second one of said plurality of floating vessels.

3. The method of treating municipal solid waste according to claim 1, wherein said floating vessel is a flattop barge made of metal, ferro-cement, or laminated cemetitious composites.

4. The method of treating municipal solid waste according to claim 1, wherein said floating vessels are double-hulled, segmented compartments, flat top, with connectors end-to-end and side-to-side, anchor links, and base post attachments for vertical construction.

5. The method of treating municipal solid waste according to claim 1, further comprising reduction of said non-recyclable waste materials through crushing, shredding, grinding, or compacting prior to sealing airtight said non-recyclable materials in said plurality of floating vessels.

6. The method of treating municipal solid waste according to claim 1, wherein said segregation of waste is conducted either inland or offshore.

7. The method of treating municipal solid waste according to claim 1, further comprising converting said non-recyclable materials into construction materials by grinding and mixing said non-recyclable materials with sand and cement to form hollow blocks, aggregates, or other construction materials.

8. The method of treating biodegradable waste according to claim 1, wherein composting or vermi-composting is conducted on the flat-top surface of said floating vessels.

9. The method of recycling biodegradable waste according to claim 1, further comprising offshore food production.

10. The method of food production according to claim 9, wherein food production is defined by livestock, marine life, and crop raising.

11. An offshore complex for the treatment and disposal of municipal solid waste, comprising:
a waste segregation facility wherein municipal solid waste are segregated into recyclables, non-recyclables, and biodegradable materials;
a plurality of flat-top floating vessels wherein said non-recyclable waste segregated at said waste segregation facility are deposited and sealed; and,
wherein at least one of said flat-top floating vessels is used for composting or vermi-compostng of said biodegradable waste materials.

12. The offshore complex according to claim 11, wherein at least one of said plurality of floating vessels is used to raise crops, livestock, or marine life.

13. The offshore complex according to claim 11, wherein dedicated power barges with windmills, biogas digesters, solar panels, and wave, ocean current, or tide energy equipment are means for supplying the power requirements for said offshore complex.

14. The offshore complex according to claim 11, wherein dedicated desalination barges and built-in rainwater catchments in each barge are means for supplying the water requirements for said offshore complex.

15. The offshore complex according to claim 11, wherein dedicated barges for personnel living quarters, water reservoirs, oil depots, waste water treatment, and feed mills are provided.

16. The offshore complex according to claim 11, wherein the flat bottoms of said plurality of floating vessels have attachments to facilitate the formation of artificial coral reefs at the bottom of each floating vessel and in selected open spaces between floating vessels.

17. The offshore complex according to claim 11, wherein a constantly expanding and movable real estate or land reclamation comprising of inter-connected flattop floating vessels is formed by the continuous arrival of said depository floating vessels containing said sealed non-recyclable waste materials.
